(19) United States
(12) Patent Application Publication
(10) Pub. No.: US 2010/0157387 A1
(43) Pub. Date: Jun. 24, 2010

(54) DOCUMENT READER

(75) Inventor: Lee Boon Chen, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/639,716

(22) Filed: Dec. 16, 2009

(30) Foreign Application Priority Data
Dec. 24, 2008 (JP) 2008-327223

(51) Int. Cl. H04N 1/04

(52) U.S. Cl. 358/488; 358/474

(57) ABSTRACT

A document reader includes a housing which includes an opening in a reading surface, an image pickup unit which is disposed in the housing and reads a document via the opening, and a light-transmittable cover which covers the opening and includes a white reference region used in setting a white reference.

### CROSS-REFERENCES TO RELATED APPLICATIONS

Priority is claimed under 35 U.S.C. §119 to Japanese Application No. 2008-327223, filed on Dec. 24, 2008 which is hereby incorporated by reference in its entirety.

### BACKGROUND

1. Technical Field

The present invention relates to a document reader which reads characters and images on documents.

2. Related Art

As a document reader (which is also referred to as an image reader), stationary scanners are widely used. The stationary type scanner moves a document reading unit disposed in the apparatus or a document so as to realize scanning of the document. Handy type scanners are also known in which the document is read by moving (scanning) the document reader body. In order to perform the reading properly, the scanners are subjected to a setting process of a white reference and a black reference (for example, JP-A-2000-316068). In the stationary type scanner in which the document reading unit is moved, a white reference plate is disposed outside the platen so as to be a reference of a white reference setting process. In the handy type scanner, since there is no platen, a white reference plate, for example, is disposed in the vicinity of a document reading window.

However, in general, since lens aberration increases as positions on the lens move away from the center thereof, when the white reference plate is disposed in the vicinity of the document reading window, there is a problem in that an actual document reading region becomes smaller than that of the document reading window.

### SUMMARY

An advantage of some aspects of the invention is to perform a white reference process without reducing a document reading region.

The invention employs various aspects as described in the following in order to solve at least one of the above-mentioned problems.

A first aspect is to provide a document reader. According to the first aspect of the invention, there is provided a document reader including: a housing which includes an opening in a reading surface; an image pickup unit which is disposed in the housing and reads a document via the opening; and a light-transmittable cover which covers the opening and includes a white reference region used in setting a white reference.

In the document reader according to the first aspect, since there is provided the cover which is a light-transmittable cover for covering the opening and includes the white reference region used in setting the white reference, it is possible to perform a white reference process without reducing a document reading region.

In the document reader according to the first aspect, the cover may include the white reference region in a central region thereof. In this case, the omission of the read image due to the white reference region can be easily compensated.

The document reader according to the first aspect may further include a storage unit which stores position information of the white reference region. In this case, the white reference region is easily specified, and it is possible to improve the accuracy of the white reference setting process.

The document reader according to the first aspect may further include a white reference setting unit which performs a white reference setting process using the white reference region included in an image which is obtained by the image pickup unit. Here, the white reference setting unit performs a white reference setting process using an image except an image corresponding to a peripheral portion of the white reference region among the read image of the white reference region. In this case, it is possible to improve the accuracy of the white reference setting process.

### BRIEF DESCRIPTION OF THE DRAWINGS

The invention will be described with reference to the accompanying drawings, wherein like numbers reference like elements.

FIG. 1 is a diagram illustrating a usage example of a mouse scanner according to an embodiment;

FIG. 2 is a plan view illustrating a mouse scanner according to an embodiment;

FIG. 3 is a bottom view illustrating a document reading surface of a mouse scanner according to an embodiment;

FIG. 4 is a front view illustrating a mouse scanner according to an embodiment;

FIG. 5 is a side view illustrating a mouse scanner according to an embodiment;

FIG. 6 is a functional block diagram schematically illustrating an internal configuration of a mouse scanner according to an embodiment;

FIG. 7 is a diagram illustrating an image read by a mouse scanner according to an embodiment;

FIG. 8 is a diagram illustrating a synthesizing process of image data read by a mouse scanner according to an embodiment;

FIG. 9 is a diagram illustrating a forming position of a white reference region according to a first modified example; and

FIG. 10 is a diagram illustrating a forming position of a white reference region according to a second modified example.

### DESCRIPTION OF EXEMPLARY EMBODIMENTS

In the following, a document reader according to the invention will be described with reference to the accompanying drawings on the basis of the embodiment.

### A. Configuration of Document Reader

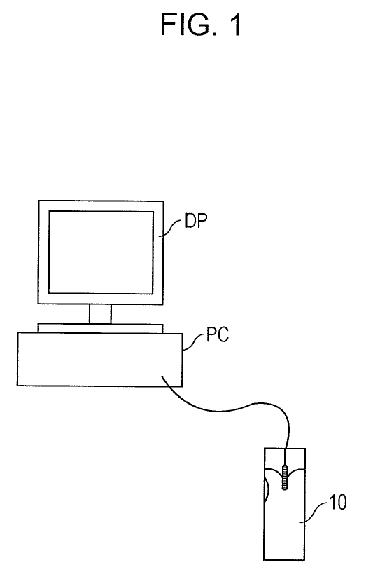

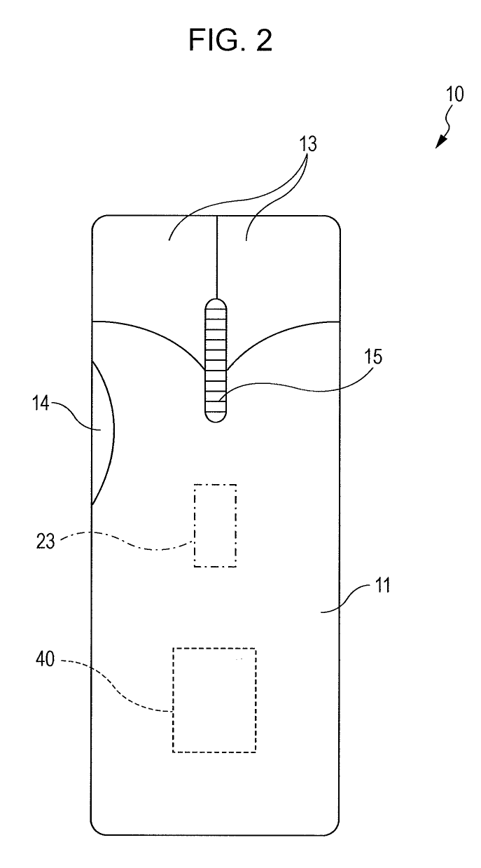

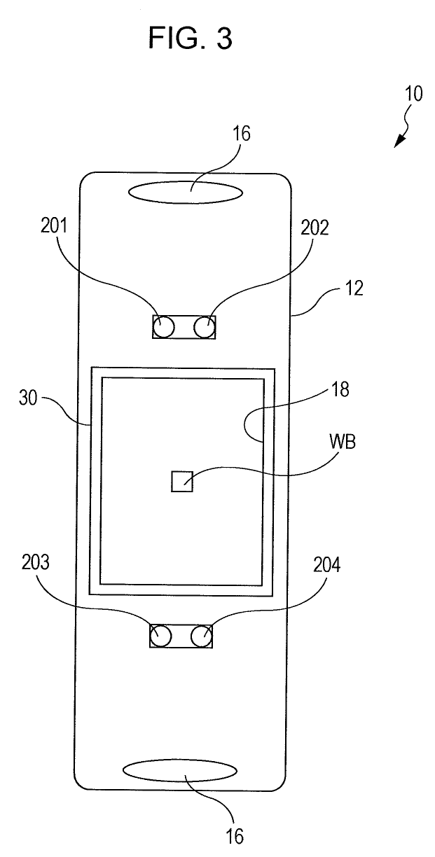

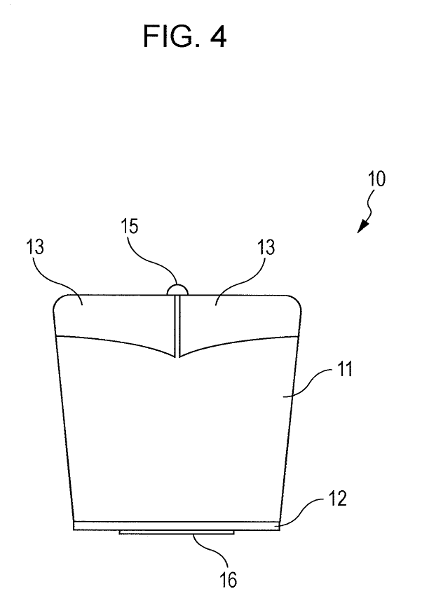

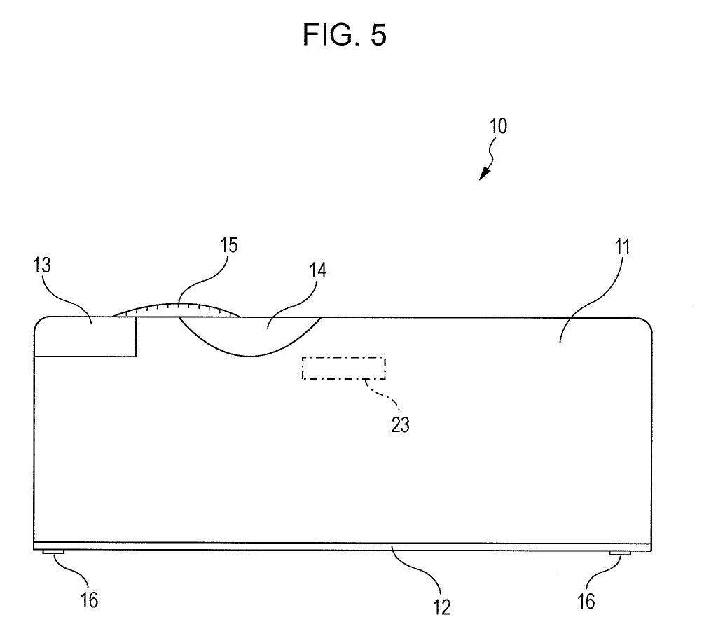

An appearance of a mouse scanner will be described as the document reader according to the embodiment. FIG. 1 is a diagram illustrating a usage example of the mouse scanner according to the embodiment. FIG. 2 is a plan view illustrating the mouse scanner according to the embodiment. FIG. 3 is a bottom view illustrating a document reading surface of the mouse scanner according to the embodiment. FIG. 4 is a front view illustrating the mouse scanner according to the embodiment. FIG. 5 is a side view illustrating the mouse scanner according to the embodiment.

The mouse scanner 10 is provided with a function as a document reader and a function as a pointing device. As shown in FIG. 1, the mouse scanner 10 is connected to a personal computer PC via a connection cord so as to be used. In the case of the function as the pointing device, a pointer on the display DP connected to the personal computer PC moves according to operations of the mouse scanner 10. In the case of the function as the scanner, when the document is scanned by the mouse scanner 10, the personal computer PC uses read-document image data which is transmitted from the mouse scanner 10 at any time and position information (X-Y coordinate information) at the time of reading the document, so as to synthesize the read image data. Thus, the image data corresponding to the entire document is synthesized. Therefore, on the display DP, the image of the read document is displayed at any time in accordance with reading timing.

The mouse scanner 10 is provided with a housing 11 in a substantially rectangular parallelepiped shape and a bottom surface part 12 which is the bottom surface of the housing 11. In addition, as shown in FIG. 4, the housing 11 has a shape of which a width in a short-side direction narrows as it comes near to the bottom surface 12 so as to grab easily with one's palm. As shown in FIGS. 2 and 5, on the upper surface of the housing 11, there are provided buttons 13 and a wheel 15 which serve as the pointing device, and a scanner selecting button 14 which is used to operate as the scanner. The mouse scanner 10 is provided with an image pickup unit 23 and a control unit 40 therein. In this embodiment, when the scanner selecting button 14 is pressed while the mouse scanner 10 is serving as the pointing device, the mouse scanner 10 serves as the scanner. When the scanner selecting button 14 is pressed while the mouse scanner 10 is serving as the scanner, the function as the scanner is removed. Alternatively, while the scanner selecting button 14 continues to be pressed, the mouse scanner 10 may serve as the scanner.

As shown in FIG. 3, in the bottom surface part 12 of the mouse scanner 10, that is, a document reading surface, first to fourth position detecting sensors 201 to 204, a document reading opening 18, a cover 30, and a pad 16.

In this embodiment, the first and second position detecting sensors 201 and 202 form a pair with each other, the third and fourth position detecting sensors 203 and 204 form a pair with each other. These two pairs are disposed so as to face each other with the document reading opening 18 interposed therebetween in the longitudinal direction of the housing. The first to fourth position detecting sensors 201 to 204 each is an optical sensor using a light source such as a laser sensor or an LED, and each of which is mounted on a substrate (not shown). These position detecting sensors 201 to 204 each is a single component, and each of which can detect a travel amount of the mouse scanner 10 in the X direction and the Y direction. Two or more position detecting sensors are provided and difference between the output values of the respective position detecting sensors is used, so that a rotation amount can be detected in addition to the travel amount of the mouse scanner 10 in the X direction and the Y direction.

The document reading opening 18 is a rectangular opening through which the mouse scanner 10 reads the document, and is covered with a light-transmittable cover 30. In the peripheral portion of the document reading opening 18, a flange is formed such that the flange is hollow into the housing 11 from the bottom surface part 12, so that the cover 30 does not protrude to the outside (document side) of the bottom surface part 12. The cover 30 may employ any cover made of resin or glass as long as it has characteristics capable of transmitting the irradiating light to the document and the reflected light from the document. Since the cover 30 is disposed so as not to come into contact with the document as described above, the transparent resin cover is generally used. At the central portion (central point) of the cover 30, a white reference region WB is formed so as to supply a white reference which is used in a white reference setting process performed in the scanner. The white reference region WB is a region of 1 mm×1 mm, for example. When resolution of the image pickup unit 23 is 300 dpi, the white reference region WB corresponds to a pixel region of 12 pixel×12 pixel.

The pads 16 are small piece members for improving operability of the mouse scanner 10 by reducing contact resistance of a document surface and a contact surface at the time of operating the mouse when the document is read. For example, resin with low surface resistance, such as Teflon resin, is employed.

As shown in FIG. 5, the image pickup unit 23 is disposed in the mouse scanner 10 and above the document reading opening 18. The image pickup unit is provided with a photoelectric conversion device (image pickup device), such as CCD or CMOS, for converting optical information into electrical information, a light source unit for irradiating light for reading onto a reading object, and a reflecting unit. In the photoelectric conversion device, R, G, and B filters are disposed in a predetermined order. In addition, the photoelectric conversion device is provided with plural photoelectric conversion elements (image pickup elements) which output voltage signals or current signals according to light intensity received therein. The image pickup unit 23 outputs three components of electrical signal value (image signal) of R component, G component, and B component which indicate one pixel of a reading object. For example, when 8 bits of a gradation value are assigned to each component, the image pickup unit 23 outputs a value of 0 to 255 for each component.

### Internal Configuration of Mouse Scanner

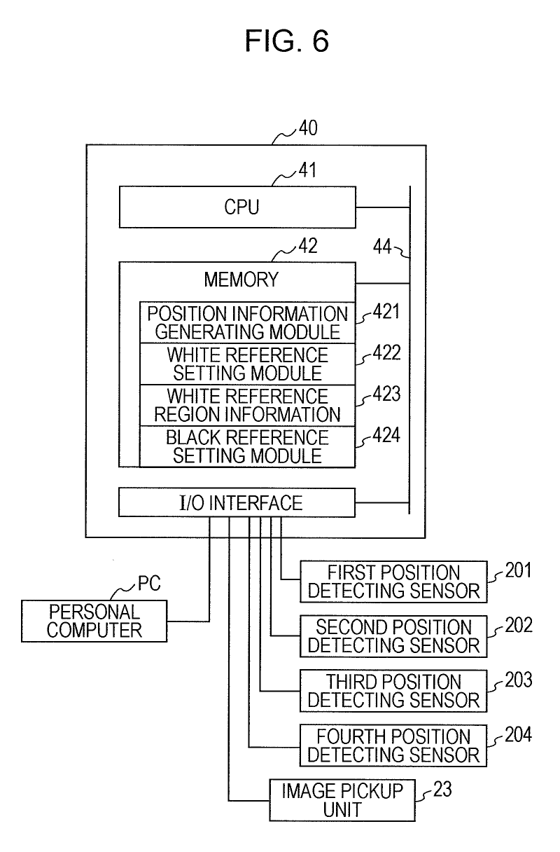

FIG. 6 is a functional block diagram schematically illustrating an internal configuration of the mouse scanner according to the embodiment. The mouse scanner 10 according to this embodiment is provided with the control unit 40. The control unit 40 is provided with a CPU 41, a memory 42, an I/O interface 43, and a bidirectional internal bus 44. The control unit 40 is connected to the personal computer PC via a connection cable. The CPU 41 is a so-called central processing unit, performs various programs stored in the memory 42, so as to cause the mouse scanner to serve as the pointing device or the scanner. The memory 42 is provided with a position information generating module 421, a white reference setting module 422, white reference region information 423, and a black reference setting module 424. In addition, the memory 42 is provided with an image developing region for developing image data which is imaged (read) by the image pickup unit 23. The I/O interface 43 is connected to the first to fourth position detecting sensors 201 to 204 and the image pickup unit 23, and is connected to the personal computer PC via the connection cable. The CPU 41, the memory 42, and the I/O interface 43 are connected to one another capable of performing bidirectional communication via the bidirectional internal bus 44.

When the mouse scanner 10 is used as the scanner, the position information generating module 421 uses position detection signals which are output from the first to fourth position detecting sensors 201 to 204, and generates position information indicating the position of the mouse scanner 10. When the mouse scanner 10 is used as the mouse, the mouse scanner 10 uses the position detection signals which are output from the first to fourth position detecting sensors 201 to 204, and generates the position information indicating the position of the pointer using the position detection signal which are output from the first to fourth position detecting sensors 201 to 204. When the mouse scanner 10 is used as the scanner, the position information generated by the position information generating module 421 and the read image data are transmitted to the personal computer PC via the connection cable. When the mouse scanner 10 is used as the mouse, the position information generated by the position information generating module 421 is transmitted to the personal computer PC via the connection cable as information indicating the operation amount (travel amount) of the mouse. The personal computer PC moves the pointer which is displayed on the display DP according to the received position information (X-Y coordinate information). In this embodiment, since four position detection signals 201 to 204 are provided, the position information generating module 421 may use the position detection signals from any two of the position detecting sensors which output the position detection signals so as to form the position information.

When the mouse scanner 10 is used as the scanner, the white reference setting module 422 sets a white reference using the white reference region WB. Specifically, when the scanner selecting button 14 is pressed, the white reference setting module 422 obtains a read image, which is used in the white reference setting process, via the image pickup unit 23. In this embodiment, since the white reference region WB is formed at the central portion of the cover 30, the read image includes an image corresponding to the white reference region WB. In addition, since the position information of the white reference region WB is stored in the memory 42, the white reference setting module 422 can easily and accurately specify the image region (pixel position) corresponding to the white reference region in the obtained read image.

The white reference setting module 422 determines a gain amount such that an average value of the respective R, G, and B component values of the pixel data which is output from the image pickup unit 23 and corresponds to the white reference region WB, that is, a maximum value of the signal average value of each color of the R, G, and B components which are output from the image pickup unit 23 and corresponds to the white reference region WB is not more than a predetermined signal value. Specifically, the white reference setting module 422 determines a gain value which is applied on an input signal input to an analog front-end circuit (not shown). Here, for example, when the signal level (gradation of the respective R, G, and B components of the image data) is expressed with 8 bits (0 to 255), the predetermined signal value is 230±10. In addition, adjustment of the gain value is repeatedly performed on the analog signal values of each color of the R, G, and B components until the signal values output from the analog front-end circuit reaches the range of the predetermined signal value. Further, in this embodiment, in order to improve accuracy, the outermost pixel data of the white reference region WB among the pixel data corresponding to the white reference region WB is not used. This is because the pixel data of the outermost pixel is easy to affect the reading surface which surrounds (or neighbors) the white reference region WB, so that there is a high possibility that the pixel data corresponding to the white reference region WB is not shown. Therefore, for example, when the white reference region WB is a region of 12 pixel×12 pixel, the pixel data (output signal) corresponding to 10 pixel×10 pixel except the outermost pixels is used in the white reference setting process.

When the mouse scanner 10 is in a correct posture, that is, when the bottom surface part 12 comes into contact with the reading surface, the black reference setting module 424 adjusts an offset amount such that the average value of the signal values of each color of the R, and B components which are output from the image pickup unit 23 is in the predetermined signal value range on the basis of the input signal from an optical black pixel on which light from the light source is not incident structurally. Specifically, the black reference setting module 424 determines the offset value which is applied on an input signal input to an analog front-end circuit (not shown). Here, for example, when the signal level (gradation of the respective R, G, and B components of the image data) is expressed with 8 bits (0 to 255), the predetermined signal value range is 4 to 6. In addition, adjustment of the offset value is repeatedly performed on the analog signal values of each color of the R, G, and B components until the signal values output from the analog front-end circuit reaches the range of the predetermined signal value.

The black reference setting module 424 may perform the black reference setting process on condition that the mouse scanner 10 is not lifted up. When the mouse scanner 10 is lifted up, ambient light (environmental light) may be incident on the optical black pixels, and there is some concern that incidence of the ambient light may result in deterioration in black setting accuracy. In order to prevent the problem, the black reference setting process may be performed in a state where the bottom surface part 12 of the mouse scanner 10 comes into contact with the reading surface. Further, whether or not the mouse scanner 10 is lifted up can be detected by lift-up signals which are output from the first to fourth position detecting sensors 201 to 204. As described above, the position detecting sensors output detection light onto the reading surface (document surface), and realizes the position detection on the basis of the reflected light from the reading surface. Here, the time period from irradiation of the detection light to reception of the reflected light is substantially constant. However, when the bottom surface part 12 is separated from the reading surface, the reflected light cannot be received in the constant time period. Therefore, the position detecting sensors cannot output the position detection signal, but signals, such as a non-contact signal, a reading inhibition signal, and a position detecting inhibition signal, are output. These signals are used as the lift-up signal, so that it is possible to determine whether or not the mouse scanner 10 is lifted up from the reading surface.

### Synthesizing Process of Image Read by Mouse Scanner

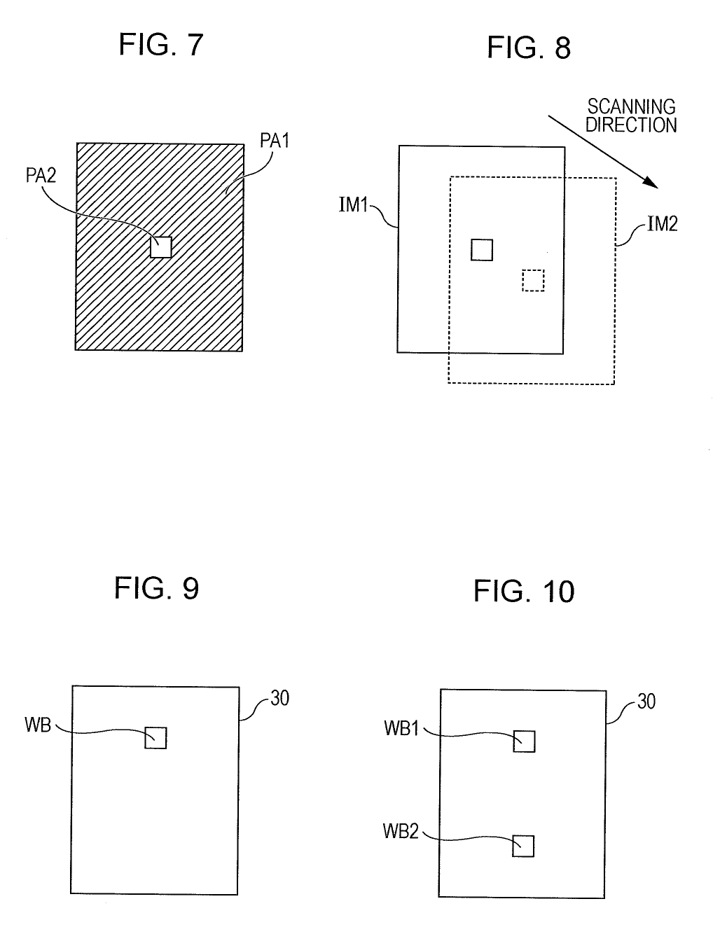

FIG. 7 is a diagram illustrating an image read by the mouse scanner 10 according to the embodiment. FIG. 8 is a diagram illustrating a synthesizing process of image data read by the mouse scanner 10 according to the embodiment. In this embodiment, the white reference region WB is formed in the central portion of the cover 30. Therefore, as shown in FIG. 7, an image PA1 is read by the mouse scanner 10 at any timing (position), and a non-imaging region PA2 corresponding to the white reference region WB is included therein. Further, the images as shown in FIGS. 7 and 8 conceptually illustrate an image which is developed in the memory 22 of the mouse scanner 10 or in the memory of the personal computer PC, or a display image which is displayed on the display DP connected to the personal computer PC.

Since the mouse scanner 10 scans the document through a user, the positions of the non-imaging region PA2 formed at imaging timing (reading timing) are different. That is, as shown in FIG. 8, a first image IM1 is read at any timing, and a second image IM2 is read at the next timing. At this time, a range on the document which is the non-imaging region in the first image IM1 is read in the second image IM2 (an image is generated). Further, the reading timing in this embodiment is timing for outputting the position information by the first to fourth position detecting sensors 201 to 204.

Therefore, the non-imaging region in the first image IM1 can be compensated using the second image IM2. In this embodiment, the compensation process is performed by an image synthesizing module provided at the personal computer PC. That is, the personal computer PC cuts the image corresponding to the non-imaging region PA2 omitted in the first image IM1 off from the second image IM2 so as to be synthesized with the first image IM1. In the image read by the mouse scanner 10 (image pickup unit 23), the read position information (X-Y coordinates) which is output from the position detecting sensors 201 to 204 at reading timing is associated therewith, and each pixel position constituting the read image can be specified from the resolution of the image pickup unit 23. Therefore, the X-Y coordinates of the non-imaging region PA2 in the first image IM1 is specified and the travel amount (X, Y) of the mouse scanner 10 is subtracted therefrom, so that the X-Y coordinates of the region to be cut off from the second image IM2 can be specified. The personal computer PC fits (synthesizes) the image cut off from the second image IM2 into the non-imaging region PA2 in the first image IM1, so that the read image without the non-imaging region can be generated.

Further, the image synthesizing module in the personal computer PC may sequentially display the read images on the display DP using the image data which is read by the mouse scanner 10 and stored in the memory. Alternatively, using the image data completed in the synthesizing process, the personal computer PC may display the image without the non-imaging region PA2 on the display DP. In the former case, the first image IM1 with the non-imaging region PA2 is first displayed on the display DP, and the first image IM1 without the non-imaging region PA2 and the second image IM2 with the non-imaging region PA2 are displayed at the next reading timing. Further, the non-imaging region PA2 in the second image IM2 may be compensated using the first image IM1, or may be compensated using a third image to be read at the next reading timing.

As described above, since the mouse scanner 10 according to this embodiment includes the white reference region WB formed in the cover 30, the white reference setting process can be performed without narrowing down a reading effective region of the document. In particular, since the white reference region WB is provided at the central portion of the cover 30, a reading effective region of the document is reduced to a minimum, so that the white reference setting process can be performed. That is, the central portion of the cover 30 is matched with a focus of the lens provided at the image pickup unit 23 in many cases, a magnification error thereof is basically 0, and that is the brightest place. Therefore, the region required as the white reference region WB can be reduced. As a result, the reading effective region of the document becomes smaller as much as the area of the white reference region WB. For example, the dimension required as the white reference region WB is 1 mm×1 mm, and even though the margin is set to 10%, only the area of 1.1 mm² is required. Therefore, when the dimension of the document reading opening 18 is 27 mm×20 mm, the reading effective region of the document with respect to the document reading opening 18 is merely reduced by about 2%.

On the other hand, in the known example in which a frame-like white reference region is provided at an inner peripheral portion of the document reading opening, the magnification error in the document reading opening is large, and the frame-like white reference region may be read at the time of reading the document. In order to avoid the defect, there is a need to make small the reading effective region of the document in consideration of the magnification error. For example, when the frame-like white reference region with a width of 1 mm is formed in the inner peripheral portion of the document reading opening, the reading effective region of the document is set as a region in which 2.5% region of the document reading opening in the longitudinal and lateral dimension is removed from the document reading opening. In this case, when the dimension of the document reading opening is 27 mm×20 mm, the area of the reading effective region of the document becomes 23.65 mm×17.00 mm=402.05 mm². The reading effective region is reduced to be about 25% of the document reading opening. Here, 23.65=27−(1×2: frame width)−(0.675×2: considering magnification error), and 17.00=20-(1×2: frame width)−(0.5×2: considering magnification error). Therefore, in order to obtain the reading effective region equal to the document reading opening from the beginning, there is a need to make large the dimension of the document reading opening so as to increase about 30% of an area ratio. As a result, the size of the mouse scanner becomes larger about 30%.

As described above, in the mouse scanner 10 according to this embodiment, the white reference setting process can be performed while the reading effective region of the document is secured to be equal to the area of the document reading opening 18 without increasing the area of the document reading opening 18. Further, as exemplified above, the dimension of the white reference region WB and the dimension of the document reading opening 18 may be larger than or less than the exemplified dimension.

In addition, in the mouse scanner 10 according to this embodiment, since the pixel data (RGB signals) obtained by the outer peripheral pixels of the white reference region WB is not used in the white reference setting process, it is possible to set the white reference, that is, to determine the gain amount which is applied on the reading image data (reading signal) without being influenced by the color and the shape of the reading object surrounding the white reference region WB. Even though the magnification error at the central portion of the document reading opening 18 is small, but the pixel data obtained by the outer peripheral pixels of the white reference region WB is not used in the white reference setting process, so that it is possible to improve the accuracy of the white reference setting process.

In addition, the image of the non-imaging region PA2, which is omitted by providing the white reference region WB at the central portion of the cover 30, can be compensated using the image data which is read at other timing. Therefore, even though the white reference region WB is provided at the central portion of the cover 30, the read image quality is not adversely affected. In particular, by providing the white reference region WB at the central portion of the cover 30, even though the mouse scanner 10 moves in any direction of the left, right, top, and bottom directions (X-Y direction), for example, in the inclined direction as shown in FIG. 8, the image of the non-imaging region PA2 corresponding to the white reference region WB can be compensated using the next image reading timing, that is, the image taken at the next timing.

### Modified Example

(1) Modified examples according to the white reference region WB will be described with reference to FIGS. 9 and 10. FIG. 9 is a diagram illustrating the forming position of the white reference region WB according to a first modified example. FIG. 10 is a diagram illustrating the forming position of the white reference region WB according to a second modified example.

As shown in FIG. 9, in the first modified example, the white reference region WB is disposed at the central portion of one of the regions which are obtained by dividing the rectangular cover 30 in the short-side direction. When the magnification error of the lens of the image pickup unit 23 is considered, it is preferable that the white reference region WB be formed at the central point of the cover 30. However, even though the white reference region WB is shifted from the central point or roughly disposed in the vicinity of the center portion of the cover 30, it is difficult to be adversely affected by the magnification error of the lens of the image pickup unit 23. Therefore, as shown in FIG. 9, even though the white reference region WB is shifted from the central point of the cover, the effect of the embodiment as described above can be obtained.

In a second modified example as shown in FIG. 10, the white reference regions are disposed at both central portions of the regions which are obtained by dividing the rectangular cover 30 in the short-side direction, as the respective white reference regions WB1 and WB2. Also in this case, the areas occupied by the respective white reference regions WB1 and WB2 are small, and there is no need to set the margin in consideration of the respective white reference regions WB1 and WB2. Therefore, the reading effective region of the document is not reduced. In addition, by using two white reference regions WB1 and WB2, the white reference setting process can be performed in consideration of the deviation in light intensity in the reading effective region of the document or the deviation of the image pickup element provided at the image pickup unit 23. As a result, it is possible to improve the image quality of the obtained images, and in particular, the gradation characteristics. As described above, it is preferable that the white reference region WB be formed in the central region of the cover 30. It is possible to suppress the reduction of the reading effective region of the document as long as the white reference region WB is not formed all around the cover 30. Therefore, the white reference region WB can be formed at any region of the cover 30.

(2) In the above-mentioned embodiment, the position information 423 of the white reference region WB is stored in the memory 42 of the control unit 40. However, the position information 423 of the white reference region may not be provided. In this case, the white reference setting module 422 specifies an achromatic region, among the image (plural pixels) obtained by reading, with high brightness as the white reference region. In addition, the white reference setting module 422 performs the above-mentioned white reference setting process using the average value of the output signals (or pixel data of the R, G, and B components) of the R, G, and B components corresponding to the specified white reference region.

(3) In the above-mentioned embodiment, the mouse scanner 10 is in the rectangular parallelepiped shape, and is described using the document reading opening 18 in the rectangular shape (long rectangular shape) in order to secure the maximum reading area. However, it may be employed with the document reading opening in a circular shape. For example, it is useful when the mouse scanner 10 is in a semispherical shape. Besides, various shapes can be taken according to a two-dimensional shape of the reading surface of the mouse scanner.

(4) In the above-mentioned embodiment, the compensation process of the non-imaging region PA2 is performed by the personal computer PC. However, the compensation process may be performed by the mouse scanner 10. In this case, the mouse scanner 10 is provided with an image synthesizing module for performing the image synthesizing process in the memory 22. The memory 22 is provided with a storage region for developing the first image data read at the first timing and a working region for dynamically generating the synthetic image data using the second image data read at the second timing. In addition, the memory 22 is provided with a storage region for developing the second image data, and once the second image data is developed, and then the synthesizing process of the image data may be performed by the image synthesizing module. In both cases, the synthesized image data is output to the personal computer PC, so that the image without the non-imaging region PA2 is displayed on the display DP.

(5) In the above-mentioned embodiment, the personal computer PC and the mouse scanner 10 are connected to each other via the connection cable, but they may be connected by wireless communication.

(6) In the above-mentioned embodiment, the mouse scanner provided with the mouse function (pointing device) is described as an example, but it may be realized as a handy scanner without the mouse function. That is, a series of image reading processes as described in the embodiment can be performed regardless of existence of the mouse function.

Hereinbefore, the invention is described on the basis of the embodiment and the modified examples. The above-mentioned embodiment of the invention is provided to easily understanding the invention, and the invention is not limited thereto. The invention can be changed and improved without departing from the scope and claims of the Invention, and includes the equivalence thereof.

What is claimed is:

1. A document reader comprising:
a housing which includes an opening in a reading surface;
an image pickup unit which is disposed in the housing and reads a document via the opening; and
a light-transmittable cover which covers the opening and includes a white reference region used in setting a white reference.

2. The document reader according to claim 1,
wherein the cover includes the white reference region in a central region thereof.

3. The document reader according to claim 1, further comprising:
a storage unit which stores position information of the white reference region.

4. The document reader according to claim 1, further comprising:
a white reference setting unit which performs a white reference setting process using an image of the white reference region included in an image which is read by the image pickup unit,
wherein the white reference setting unit performs a white reference setting process using an image except an image corresponding to a peripheral portion of the white reference region among the read image of the white reference region.
